(19) United States
(12) Patent Application Publication
(10) Pub. No.: US 2007/0263605 A1
(43) Pub. Date: Nov. 15, 2007

(54) SMS-Initiated VoIP

(75) Inventors: Leonardo W. ESTEVEZ, Rowlett, TX (US); Dongan ZHANG, Plano, TX (US)

Correspondence Address: TEXAS INSTRUMENTS INCORPORATED, P O BOX 655474, M/S 3999, DALLAS, TX, 75265, US

(73) Assignee: Texas Instruments, Inc., Dallas, TX (US)

(21) Appl. No.: 11/380,326

(22) Filed: Apr. 26, 2006

(51) Int. Cl. H04L 12/66

(52) U.S. Cl. 370/356

(57) ABSTRACT

A system comprising a first communication device and a second communication device which transmits a text-based message to the first communication device. The message comprises an internet protocol (IP) address associated with the second communication device. If VoIP telephony is possible between the first and second communication devices, the first communication device automatically extracts the IP address from the message and uses the IP address to automatically establish a voice over Internet protocol (VoIP) call with the second communication device.

### BACKGROUND

Voice over Internet Protocol (VoIP) communication comprises the transfer of audio signals between two or more devices via a computer network employing IP technology. When the user of a first communication device desires to initiate a VoIP call with the user of a second communication device, the first communication device not only must possess the IP address of the second communication device, but it also must know whether the first and second communication devices are engaged on a common IP network. Moreover, such VoIP calls often require various security features and infrastructure to ensure the security of the calls. Improvements in these areas are desirable.

### SUMMARY

The problems noted above are solved in large part by a system and method by which multiple VoIP-enabled communication devices are able to establish phone calls with each other, even when each device initially does not have the information necessary to establish a phone call with the other device. An illustrative embodiment includes a system comprising a first communication device and a second communication device which transmits a text-based message to the first communication device. The message comprises an internet protocol (IP) address associated with the second communication device. If VoIP telephony is possible between the first and second communication devices, the first communication device automatically extracts the IP address from the message and uses the IP address to automatically establish a voice over Internet protocol (VoIP) call with the second communication device.

Another illustrative embodiment includes a communication device comprising control logic and memory coupled to the control logic and comprising a software application. The control logic receives data from another communication device, the data comprising an Internet protocol (IP) address of the another communication device. The control logic uses the software application to automatically extract the IP address from the data and to establish communications with the another communication device over an IP network.

Yet another illustrative embodiment includes a method which comprises receiving data from a communication device, the data comprising an Internet protocol (IP) address of the communication device. If voice over Internet protocol (VoIP) telephony is possible with the communication device, the method comprises automatically extracting the IP address from the data and establishing a VoIP call with the communication device at the IP address over an IP network.

Still another illustrative embodiment includes software instructions on one or more information carrier media, where the instructions, when executed by a processor, cause the processor to receive a text-based message from a communication device. The text-based message comprises an indicator. If the indicator indicates that the text-based message is usable to initiate a voice over Internet protocol (VoIP) phone call with the communication device, the processor establishes the VoIP call with the communication device at an IP address stored in the text-based message. The processor automatically establishes the VoIP call without an end-user of the processor providing the IP address to the processor.

### BRIEF DESCRIPTION OF THE DRAWINGS

For a detailed description of exemplary embodiments of the invention, reference will now be made to the accompanying drawings in which:

FIG. 1A shows a mobile communication device in accordance with embodiments of the invention;

FIG. 1B shows a detailed view of the mobile communication device of FIG. 1A, in accordance with embodiments of the invention;

FIG. 2A shows an illustrative VoIP setup initiated using the techniques described herein, in accordance with preferred embodiments of the invention;

FIG. 2B shows a flow diagram of a method associated with the VoIP setup of FIG. 2A, in accordance with embodiments of the invention;

FIG. 3A shows another illustrative VoIP setup initiated using the techniques described herein, in accordance with preferred embodiments of the invention; and

FIG. 3B shows a flow diagram of a method associated with the VoIP setup of FIG. 3A, in accordance with embodiments of the invention.

### NOTATION AND NOMENCLATURE

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a technique by which multiple VoIP-equipped communication devices are able to establish phone calls with each other, even when each device initially does not have the information necessary to establish a call with the other device. In particular, a first device generates and transmits a short message service (SMS) message (i.e., a text message) to a second device via a mobile telephone network, such as the Global System for Mobile Communication (GSM) network. The SMS message comprises information pertaining to the first device, including an IP address of the first device and a phone number of the first device. The second device receives the SMS message from the GSM network and, using the information contained in the SMS message, initiates a call to the first device. In some embodiments, the second device may initiate a call to the first device using VoIP technology, In other embodiments, the second device may initiate a call to the first device using the GSM network (i.e., using the phone number of the first device). In still other embodiments, the second device may send a reply SMS message to the first device with the second device's IP address and/or phone number, which the first device may use to initiate a phone call with the second device. Various such possibilities are included within the scope of disclosure. A brief description of SMS messages is now provided, followed by a discussion of the figures.

SMS messages are text-based messages which can be transferred between two communication devices, such as between two mobile phones, between a personal computer and a mobile phone, between a personal digital assistant and a second personal digital assistant, etc. SMS messages generally are transmitted via GSM networks or other cellular-technology networks, although they also may be transmitted via IP networks or other Internet-based networks. Various information may be included in an SMS message, such as a message payload, a time stamp, phone numbers, IP addresses, etc. SMS messaging also may be used to support “text messaging” or “instant messaging” between two communication devices. SMS technology may be used to browse various websites using mobile devices, to access search engines, to play games, etc. Although the embodiments disclosed herein are described in context of SMS messages, other similar messaging technology, such as enhanced messaging service (EMS) and multimedia messaging service (MMS), also may be used. In accordance with embodiments of the invention, SMS messages may be encrypted using any suitable encryption technology. A discussion of the figures is now provided.

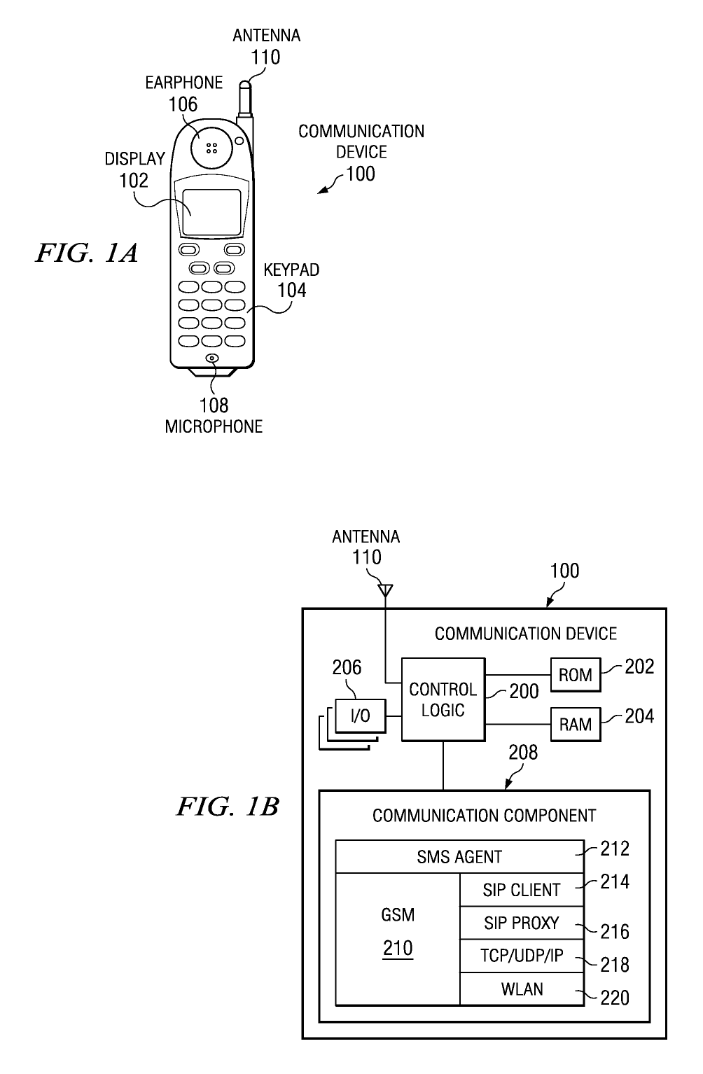

FIG. 1A shows a mobile communication device 100 comprising a display 102, a keypad 104, an earphone 106, a microphone 108 and an antenna 110. The mobile communication device 100 may comprise any suitable device, such as a mobile phone, a personal digital assistant (e.g., a BLACKBERRY® device), etc. The display 102 may comprise any suitable display technology, including light-emitting diode (LED) technology, liquid crystal display (LCD) technology, plasma technology, etc. The keypad 104 may be used by an end-user of the device 100 to enter a variety of information, including the end-user's name, telephone number, text messages, etc. The earphone 106 is used to listen to audio signals received by the device 100 and the microphone 108 is used to capture audio signals for transmission by the device 100. The antenna 110 transmits and receives signals for the device 100, for example by communicating with a GSM network or an IP network.

FIG. 1B shows a detailed view of the communication device 100. The device 100 comprises a control logic 200, such as a central processing unit or a processor, coupled to a read-only memory (ROM) 202 and a random access memory (RAM) 204. The ROM 202 and/or the RAM 204 may store various software applications executable by the control logic 200. The control logic 200 further couples to a plurality of input/output (I/O) devices 206, which generally include devices such as the display 102, keyboard 104, earphone 106 and microphone 108 of FIG. 1A. The control logic 200 still further couples to a communication component 208. The communication component 208 comprises various software applications and/or hardware components used by the device 100 to establish and sustain calls with another device via the antenna 110. As such, the communication component 208 may comprise memory (e.g., RAM) to store such software applications, a combination of memory and other hardware components, or any other combination of software and/or hardware components necessary to establish and sustain communications with another device. As shown, the communication component 208 comprises a GSM component 210, an SMS Agent 212, a session-initiation protocol (SIP) client 214, an SIP proxy 216, a transmission control protocol/user datagram protocol/Internet protocol (TCP/UDP/IP) component 218, and a wireless local area network (WLAN) component 220.

A brief explanation of each of these components follows. The GSM component 210 comprises various protocol information used to establish and sustain GSM telephone calls with another device via the antenna 110 and a GSM network. The SMS Agent 212 comprises a software application which is used to generate, send and receive SMS messages via the antenna 110. Specifically, the control logic 200 executes Agent 212, which in turn generates an SMS message comprising data pertinent to the device 100.

The control logic 200 then routes the SMS message to antenna 110, whereby the SMS message is transmitted to another device. The SIP client 214 and the SIP proxy 216 comprise software applications which are used to establish and sustain VoIP phone calls with other devices. The TCP/UDP/IP component 218 comprises both TCP/UDP protocol and IP protocol, both of which are used to transmit packets of data over an IP network. IP protocol is used to deliver data packets, and the TCP/UDP protocol is used to keep track of the packets that a message is divided into for efficient routing over an IP network. The WLAN component 220 comprises protocol which the device 100 may use to communicate with another device via a wireless, local network. For example, the WLAN component 220 may be used to establish and sustain wireless communications between two VoIP-equipped phones engaged on a common IEEE 802.11(x) wireless network.

When the device 100 participates in a VoIP call, the control logic 200 uses its SIP client 214 and SIP proxy 216 to set up the VoIP call. For example, when the device receives a call, its SIP client 214 is used to generate a call request to the SIP proxy 216. In turn, the SIP proxy 216 answers the call from the SIP client 214 and generates a call to the device itself. Further, the protocol of the TCP/UDP/IP component 218 is used as necessary to establish and sustain a call over an IP network and the protocol of the WLAN component 220 is used as necessary for calls established over a WLAN.

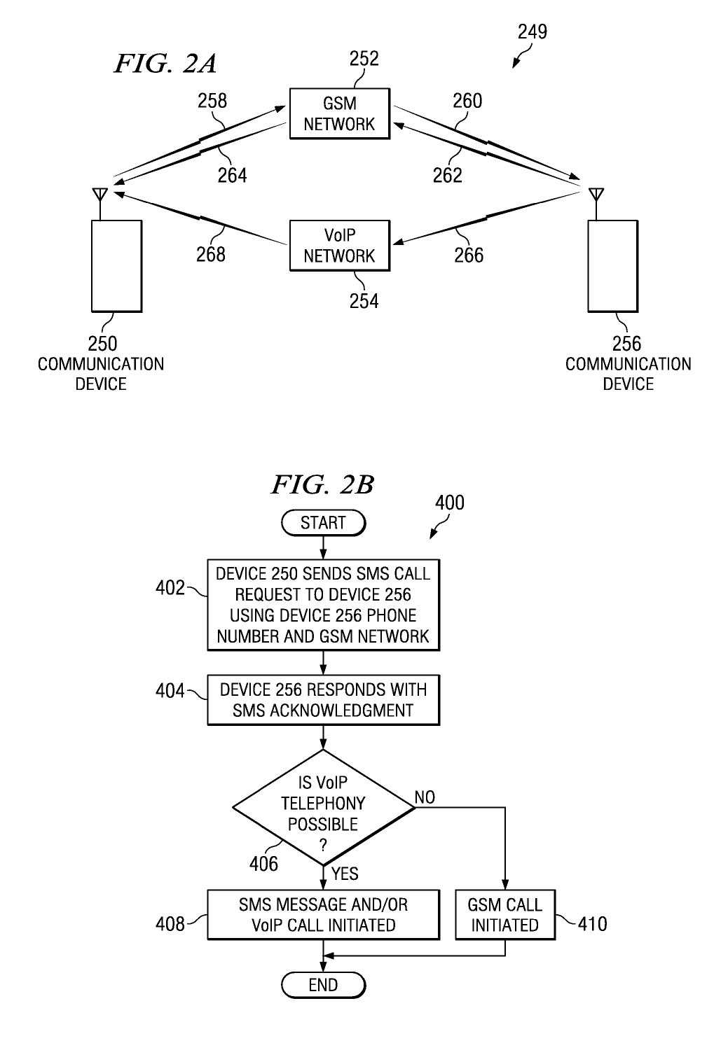

FIG. 2A depicts a communication system 249 by which a wireless communication device 250 may communicate with a wireless communication device 256, in accordance with embodiments of the invention. In at least some embodiments, each of the devices 250 and 256 comprise dual-mode phones which are equipped with both GSM and VoIP technologies. Stated in another way, each of the devices 250 and/or 256 is able to initiate a phone call with another device by dialing a phone number and communicating via a cell phone tower, or by initiating a VoIP session and communicating via an IP network. An illustrative dual-mode phone is the NOKIA® 6136. Although only two communication devices are shown, any number of communication devices may be used. Moreover, the scope of disclosure is not limited to the use of dual-mode phones. In some embodiments, desktop or laptop computers, personal digital assistants, etc, may be used with different access technologies, such as BLUETOOTH®, WiMAX® and ultrawide band (UWB).

The communication system 249 further comprises a GSM network 252 and a VoIP network 254. The GSM network 252 may comprise a base station subsystem and associated components, a network subsystem and associated components, a cell phone tower, etc. Although the network 252 is described as a GSM network, the scope of disclosure is not limited to GSM networks. Any network suitable for providing telephony between two communication devices may be used and is within the scope of disclosure. The communication system 249 also comprises a VoIP network 254. The VoIP network 254 may comprise any suitable network capable of establishing a phone call between devices 250 and 256 using IP or other Internet-related technology. Illustrative examples include a local area network (LAN), a WLAN, wireless-fidelity (Wi-Fi) hotspots or Wi-Fi technology in general, wired or wireless intranets, enterprise networks, etc. This list of examples is not exhaustive and does not limit the scope of disclosure. Various other suitable Internet-related telephony technologies are contemplated.

FIG. 2B shows a flow diagram describing a process 400 associated with the communication system 249. Referring to FIGS. 1A, 1B, 2A and 2B, the process 400 begins with the device 250 sending an SMS message to device 256 using the phone number of device 256 and the GSM network 252 (block 402). Thus, for example, the device 250 may have the phone number of device 256 stored in an address book, and the device 250 may use this phone number to transmit an SMS message to the device 256. Alternatively, an end-user of the device 250 may use the keypad 104 to input the phone number of device 256 into the device 250. In some embodiments, an SMS message may be transmitted automatically by the control logic 200. In other embodiments, the transmission of an SMS message may be partially automatic in that an end-user uses the keypad 104 to command the control logic 200 to automatically generate and transmit the SMS message. In yet other embodiments, an end-user may use the keypad 104 to manually type an SMS message and hit a “SEND” button to send the message Arrow 258 depicts the transmission of the SMS message from device 250 to the GSM network 252, and arrow 260 depicts the transmission of the SMS message from the GSM network 252 to the device 256.

The device 256 is able to distinguish the SMS message from other SMS messages, such as “instant messaging” or “chatting” text messages, using a filter (not specifically shown). The filter searches each incoming SMS message for an indicator (e.g., bits or characters) which identifies the SMS message as a call-initiating SMS message in accordance with embodiments of the invention, or as an SMS message not intended to initiate a call. If the received SMS message is recognized as a call-initiating message, the SMS Agent 212 is used to process the message as described below. Specifically, the device 256 acknowledges the received SMS message with a reply SMS message (block 404). Arrow 262 depicts the transmission of the reply SMS message from the device 256 to the GSM network 252, and arrow 264 depicts the transmission of the reply SMS message from the GSM network 252 to the device 250.

Both SMS messages may comprise a variety of data. For example, in the SMS message transmitted by the device 250, such data may include generic information such as the phone number of device 250, the name of the end-user of device 250, etc. Such data also may describe capabilities of the device 250, such as size and resolution of the display 102, whether the display 102 supports color, data rate for streaming video, instant messaging (IM) capabilities, multimedia message services (MMS), etc. The data also may delineate quality of service (QoS) guarantees (e.g., guaranteed transmission rates, error rates, etc.) and, in embodiments where the device 250 comprises global positioning system (GPS) technology, the location of the device 250. The data includes an IP address of the device 250 which the device 256 may use to reply to the device 250. The IP address of the device 250 may be assigned on an ad-hoc basis using the dynamic host configuration protocol (DHCP). DHCP is a protocol used in some networks to dynamically assign IP addresses to devices engaged on that network. Likewise, the IP address of device 256 may be assigned using the DHCP of the network of device 256. Because the IP address of each device is subject to change (e.g., due to a change in location and thus, a change in network used), the devices 250 and 256 transmit SMS messages on a regular basis to provide updated IP addresses and other relevant information. The information contained in the reply SMS message of device 256 may be similar to that in the SMS message of device 250. Like the message of device 250, the reply SMS message of device 256 may be pre-programmed or generated by an end-user.

Continuing with the process 400, the SMS Agent 212 causes the control logic 200 to determine whether a VoIP connection is possible between the devices 250 and 256 (block 406). To do this, the control logic 200 may determine whether both devices are engaged on the same network or, alternatively, on networks in communication with each other. For example, if the devices 250 and 256 are both engaged on a single WLAN access point (AP), or if device 250 is engaged on any WLAN in IP communication with the device 256, IP telephony may be possible. If VoIP telephony is possible, the SMS Agent 212 causes the control logic 200 to negotiate for network resources with the VoIP network 254, and subsequently responds to the device 250 using the IP address of device 250 received in the SMS message. The device 256 may transmit a reply SMS message via the VoIP network 254, as indicated by arrows 266 and 268, or via the GSM network 252, as indicated by arrows 262 and 264. Alternatively, the device 256 may establish and sustain a VoIP call with the device 250 via the VoIP network 254 (block 408), also indicated by arrows 266 and 268, During the call, the device 256 and the device 250 may continue to send SMS messages to each other with updated information, such as new IP addresses, etc. If a VoIP call is not possible (block 406), then at block 410, the SMS Agent 212 causes the control logic 200 to initiate a call to the device 250 using the phone number of device 250 (i.e., over the GSM network 252), as indicated by arrows 262 and 264.

Blocks 408 and 410 above are described in the context of device 256 initiating a call to the device 250. However, in at least some embodiments, the device 250 may receive a reply SMS message from the device 256 containing the IP address and phone number of device 256. The device 250 then may call the device 256 by using the IP address to establish a call over the VoIP network 254 or the phone number to establish a call over the GSM network 252.

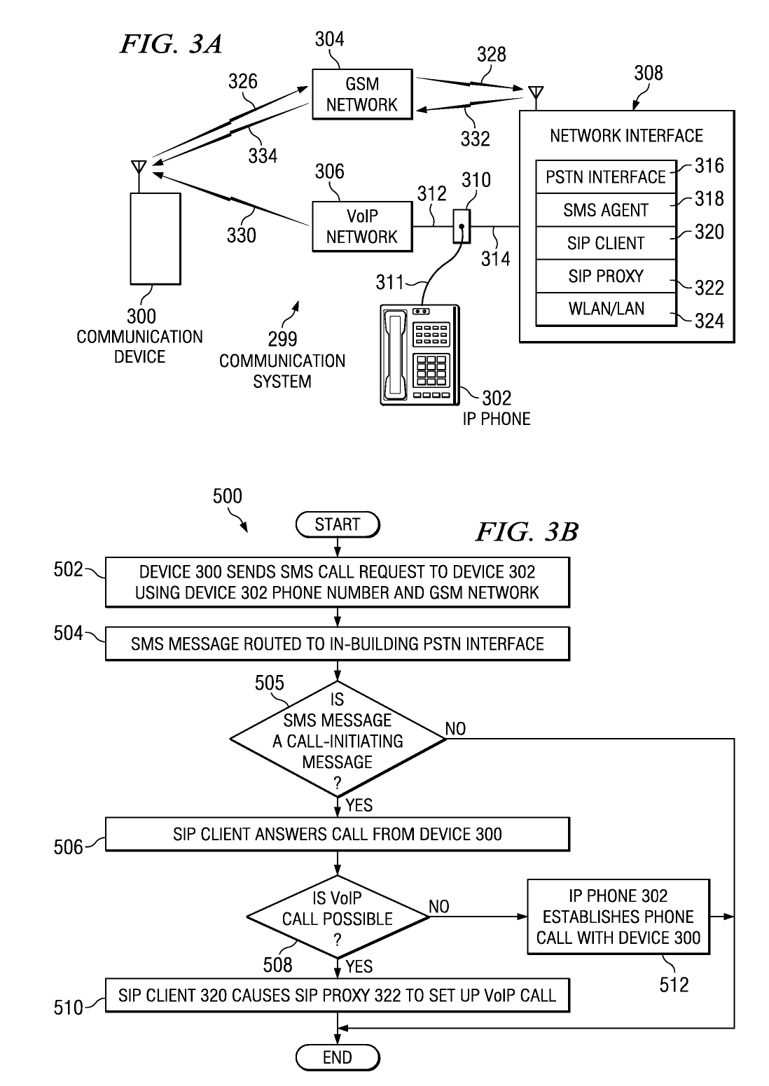

Referring now to FIG. 3A, there is shown a communication system 299 by which a wireless communication device 300 (e.g., a dual-mode phone) communicates with a wired IP phone 302. The wired IP phone 302 (e.g., with SMS capability) couples to a wall phone jack 310 (i.e., to a land-line phone connection) via a cable 311. In turn, the phone jack 310 couples to a VoIP network 306, such as a WLAN, via cable 312. The phone jack 310 also couples to a land-line network interface 308 via a cable 314. The network interface 308 comprises a plurality of software and/or hardware components similar to those of the communication component 208 of FIG. 1B. Specifically, the land-line network interface 308 comprises a public switched telephone network (PSTN) interface 316, an SMS Agent 318, an SIP client 320, an SIP proxy 322 and a WLAN or LAN 324. These components of the network interface 308 are used by the IP phone 302 as described further below. The communication system 399 still further comprises a GSM network 304. As previously mentioned, the scope of disclosure is not limited to GSM networks. The network 304 may comprise any other network suitable for establishing and sustaining telephony. Moreover, in some embodiments, the wired IP phone 302 and its associated infrastructure (e.g., phone jack 310) may be replaced with a wireless IP phone, such as the CISCO® 7920.

FIG. 3B shows a flow diagram of a method 500 associated with the communication system 299. Referring simultaneously to FIGS. 3A and 3B, the method 500 begins with the device 300 sending an SMS message to IP phone 302 using the IP phone's phone number and the GSM network 304 (block 502). Arrow 326 indicates the transfer of the SMS message from the device 300 to the GSM network 304, and arrow 328 indicates the transfer of the SMS message from the GSM network 304 to the IP phone 302. The method 500 continues with the routing of the SMS message to the PSTN interface 316 of the building containing phone jack 310 (block 504). As described above in context of FIG. 2B, the SMS Agent 318 analyzes the received SMS message to determine whether the SMS message is a call-initiating message (block 505). If the received SMS message is a call-initiating message, the method 500 continues with the SIP client 320 answering the “call,” or SMS message, from the device 300 (block 506). If a VoIP call is possible (block 508), the SIP client 320 causes the SIP proxy 322 to set up a VoIP phone call between devices 300 and 302 via the VoIP network 306 (block 510). The protocols stored in the WLAN/LAN 324 may be used by the IP phone 302 to establish and sustain the VoIP call. During a VoIP call, the IP phone 302 and device 300 may regularly exchange SMS messages to update information, such as IP addresses, etc. The SMS messages may be generated using the SMS Agent 318. VoIP calls and SMS messages are represented in FIG. 3A by arrow 330. If a VoIP call is not possible (block 508), the IP phone 302 may establish a phone call with device 300 via the PSTN interface 316 and the GSM network 304 (block 512). Arrows 332 and 334 represent a phone call established between the IP phone 302 and device 300 via GSM network 304

In at least some embodiments, the communication devices described above and in FIGS. 1A-3B are adapted to connect to the Internet and to download various software applications from the Internet. As many of the communication devices are IP-equipped devices, the devices may connect to the Internet using either a wired or wireless connection. Software applications downloaded from the Internet may include the SMS Agent 212, a modification application usable to modify SMS Agent 212, or an application capable of replacing SMS Agent 212. Software applications also may be downloaded to modify or replace other software applications in the devices, such as those shown in FIGS. 1B and 3A. Thus, for example, a communication device previously unable to establish VoIP or GSM calls in accordance with embodiments of the invention may, after downloading suitable applications (e.g., an SMS Agent 212) off of the Internet, be able to establish calls in accordance with embodiments of the invention. Communication device storage used to store the downloaded application(s), as well as information transport media (e.g., the Internet) from which the application(s) is downloaded, are collectively referred to as “information carrier media.”

In the embodiments of FIGS. 1A-3B, it is possible that a communication device transmitting an SMS message in an attempt to establish a call with another communication device may not receive a response SMS message from the other communication device. Thus, in some such embodiments, the communication device transmitting the initial SMS message may keep track of the amount of time which has elapsed (e.g., using a counter) since the SMS message was sent. If the elapsed time meets or exceeds a predetermined threshold without a response from the other communication device, the communication device may call the other communication device.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising.
a first communication device; and
a second communication device which transmits a text-based message to the first communication device, said message comprising an internet protocol (IP) address associated with the second communication device,
wherein, if VoIP telephony is possible between the first and second communication devices, the first communication device automatically extracts the IP address from the message and uses the IP address to establish a voice over Internet protocol (VoIP) call with the second communication device.

2. The system of claim 1, wherein the first communication device establishes said VoIP call with the second communication device without an end-user of the first communication device entering the IP address into the first communication device.

3. The system of claim 1, wherein the first communication device automatically determines whether VoIP telephony is possible between the first and second communication devices before establishing said call.

4. The system of claim 1, wherein said text-based message is generated by the second communication device and not by a user of said second communication device.

5. The system of claim 1, wherein said text-based message comprises a short message service (SMS) message.

6. The system of claim 1, wherein the text-based message comprises an indicator which indicates that the text-based message is usable to initiate said call.

7. The system of claim 1, wherein at least one of said communication devices transmits an SMS message to the other communication device, said SMS message comprising an updated IP address.

8. The system of claim 1, wherein the first and second communication devices comprise mobile communication devices.

9. The system of claim 1, wherein at least one of the first or second communication devices comprises a phone which couples to an IP network via a land line connection.

10. The system of claim 1, wherein, if VoIP telephony is not possible between said first and second communication devices, the first communication device establishes a non-VoIP call with said second communication device using a phone number automatically extracted by the first communication device from the message.

11. A communication device, comprising.
control logic; and
memory coupled to the control logic and comprising a software application;
wherein the control logic receives data from another communication device, said data comprising an Internet protocol (IP) address of said another communication device;
wherein the control logic uses the software application to automatically extract said IP address from the data and to establish communications with said another communication device at the IP address over an IP network.

12. The communication device of claim 11, wherein said communication device comprises a device selected from the group consisting of a dual-mode phone, a VoIP-only phone, and a land line phone.

13. The communication device of claim 11, wherein the software application comprises an application selected from the group consisting of a short message service (SMS) agent, a session initiation protocol (SIP) client and an SIP proxy.

14. The communication device of claim 11, wherein said data is selected from the group consisting of a short message service (SMS) message, an enhanced message service (EMS) message, and a multimedia message service (MMS) message.

15. The communication device of claim 11, wherein said data comprises data pertaining to said another communication device selected from the group consisting of a telephone number of said another communication device and performance parameters of said another communication device.

16. The communication device of claim 11, wherein said IP network is selected from the group consisting of a wireless local area network (WLAN), a wireless fidelity (Wi-Fi) hotspot and an intranet.

17. The communication device of claim 11, wherein the control logic establishes communications with said another communication device without an end-user of the communication device entering said IP address into said communication device.

18. The communication device of claim 11, wherein the data comprises a short message service (SMS) message having an indicator which indicates that the message is usable to establish said communications.

19. The communication device of claim 11, wherein the another communication device sends the data to the control logic, and wherein, if a predetermined amount of time elapses before a response is received from the control logic, the another communication device calls the communication device.

20. A method, comprising:
receiving data from a communication device, said data comprising an Internet protocol (IP) address of the communication device; and
if voice over Internet protocol (VoIP) telephony is possible with the communication device, automatically extracting said IP address from the data and establishing a VoIP call with the communication device at said IP address over an IP network.

21. The method of claim 20, wherein, if VoIP telephony is not possible with said communication device, automatically extracting a phone number from the data and establishing a non-VoIP call with the communication device using said phone number.

22. The method of claim 20, wherein receiving said data from the communication device comprises receiving said data from the communication device via a Global System for Mobile Communication (GSM) network.

23. The method of claim 20, wherein receiving data comprises receiving a short message service (SMS) message indicating that said SMS message is capable of being used to initiate a phone call.

24. Software instructions on one or more information carrier media, wherein the instructions, when executed by a processor, cause the processor to:
receive a text-based message from a communication device, said text-based message comprising an indicator; and
if said indicator indicates that the text-based message is usable to initiate a voice over Internet protocol (VoIP) phone call with the communication device, establish the VoIP call with the communication device at an IP address stored in said text-based message;
wherein the processor establishes said VoIP call without an end-user of the processor providing said IP address to said processor.

25. The software instructions of claim 24, wherein said text-based message comprises a short-message service (SMS) message.
